(19) United States
(12) Patent Application Publication
(10) Pub. No.: US 2026/0005227 A1
(43) Pub. Date: Jan. 1, 2026

(54) SPRAY-DRY COATING OF ELECTROACTIVE PARTICLES

(71) Applicant: GM Global Technology Operations LLC, Detroit, MI (US)

(72) Inventors: Sayed Youssef Sayed Nagy, Troy, MI (US); Yuntao Gu, Farmington Hills, MI (US); Devendrasinh Darbar, Sterling Heights, MI (US); Vamakshi Yadav, Sterling Heights, MI (US); Raneen Taha, Sterling Heights, MI (US); Lei Wang, Rochester Hills, MI (US); Zhongyi Liu, Troy, MI (US); Nicholas Paul William Pieczonka, Windsor (CA)

(21) Appl. No.: 18/757,843

(22) Filed: Jun. 28, 2024

(51) Int. Cl. H01M 4/36; H01M 4/02; H01M 4/485; H01M 4/505

(52) U.S. Cl. CPC H01M 4/366; H01M 4/485; H01M 4/505; H01M 2004/021; H01M 2004/028

(57) ABSTRACT

Systems, methods, and devices for producing coated electroactive-material particles are described. The coated electroactive-material particles may be produced by a spray-dry process including atomizing a non-aqueous solution that includes lithium niobium ethoxide and pristine cathode active material particles to produce an atomized solution, introducing the atomized solution into a drying chamber, and drying the atomized solution to produce lithium niobium oxide coated cathode active material particles. The atomizing is performed via an atomizer. The drying chamber has a gas flow to carry the atomized solution therethrough. The drying is performed via the gas flow within the drying chamber.

### INTRODUCTION

The disclosure relates to the field of electroactive materials for electrochemical cells and, more specifically, to systems and methods for producing coated electroactive-material particles.

High energy-density electrochemical cells, such as lithium-ion batteries, can be used in a variety of consumer products and vehicles. These include Hybrid Electric Vehicles (HEVs) and Electric Vehicles (EVs). However, use of electroactive materials with high specific capacities and energy densities, such as some lithium transition-metal oxides, is hindered by irreversible capacity loss and diminished cycling stability of these materials.

Some coatings have been used to alter capacities and cycling stability of electroactive materials. To provide for controlled thickness of the coatings, deposition techniques such as atomic layer deposition and chemical vapor deposition are used. However, these processes hinder scalability of producing coated electroactive materials, as well as affect certain physical properties of the coated electroactive materials. Therefore, there is a need in the art to enhance capacity retention and cycling stability as well as production of the electroactive material.

### SUMMARY

Systems, methods, and devices in accordance with the present disclosure produce coated electroactive-material particles via a spray-dry process. The specific capacity, capacity retention, and/or efficiency of battery cells incorporating the spray-dry coated electroactive-material particles disclosed herein are enhanced over similar particles of the electroactive material (both uncoated particles and particles that were coated using non-spray-dry processes).

Beneficially, systems, methods, and devices disclosed herein may provide for optimized uniformity of the coated particle, such as by optimizing the morphology, the phase homogeneity, and/or the thickness uniformity of the coating. Moreover, systems, methods, and devices disclosed herein may enhance production of coated electroactive-material particles by optimizing cost of producing coated electroactive materials, increasing the volume of coated electroactive material produced in a given time, and increasing utilization time.

Beneficially, coatings formed as disclosed herein have a microstructure with a uniform phase throughout the coating (e.g., measured by reduced defect and/or vacancy concentrations). While not being bound by theory, it is believed that this optimizes performance of the coated particles by providing consistent properties, such as ion permeability, throughout coating. Further, the coatings have a macrostructure that matches the macrostructure of the pristine electroactive material (e.g., a uniform thickness). While not being bound by theory, it is believed that this optimizes performance of the coated particles by providing consistent flux across the surface of the electroactive material.

Further, while not bound by theory, it is believed that spray-dry techniques disclosed herein optimize performance of battery cells incorporating the coated particles by forming a coating containing atomic abundances that is either the same as or closer to the desired stoichiometric abundance than coatings formed using deposition processes, such as atomic layer deposition, without employing additional materials or doping processes. For example, a lithium niobate coating formed via spray-drying as disclosed herein will have a uniform stoichiometry of LiNbO₃ throughout the coating.

Moreover, while not being bound by theory, it is believed that spray-dry techniques disclosed herein may optimize performance of battery cells incorporating the coated particles by optimizing electrolyte interphase formation, uniformity, durability, and performance.

According to aspects of the present disclosure, a method includes atomizing a non-aqueous solution that includes lithium niobium ethoxide and pristine cathode active material particles to produce an atomized solution, introducing the atomized solution into a drying chamber, and drying the atomized solution to produce lithium niobium oxide coated cathode active material particles. The atomizing is performed via an atomizer. The drying chamber has a gas flow to carry the atomized solution therethrough. The drying is performed via the gas flow within the drying chamber.

According to further aspects of the present disclosure, the atomizing, the introducing, and the drying are performed at steady state.

According to further aspects of the present disclosure, the non-aqueous solution includes lithium niobium ethoxide in an amount between 0.1 wt % and 5 wt % on the basis of the pristine cathode active material.

According to further aspects of the present disclosure, the cathode active material is a lithium- and manganese-rich material, a nickel manganese cobalt material, a lithium nickel cobalt aluminum material, a lithium nickel cobalt manganese aluminum material, a lithium iron phosphate material, a lithium manganese iron phosphate material, a lithium nickel oxide material, or a combination thereof.

According to further aspects of the present disclosure, the cathode active material is a lithium- and manganese-rich material.

According to further aspects of the present disclosure, the drying within the drying chamber occurs at a temperature from 40° C. to 90° C.

According to further aspects of the present disclosure, the drying within the drying chamber occurs at a temperature of 70° C.

According to further aspects of the present disclosure, the gas flow has a flow rate of 20 L/min.

According to further aspects of the present disclosure, each of the lithium niobium oxide coated cathode active material particles includes a coating of lithium niobium oxide defining a uniform phase.

According to further aspects of the present disclosure, the lithium niobium oxide coating defines a uniform thickness, the uniform thickness is 0.1 nm to 5 nm, and the lithium niobium oxide coating shares a macrostructure of the pristine cathode active material particle.

According to aspects of the present disclosure, lithium niobium oxide coated cathode active material particles are formed by atomizing a non-aqueous solution that includes lithium niobium ethoxide and pristine cathode active material particles to produce an atomized solution, introducing the atomized solution into a drying chamber, and drying the atomized solution to thereby produce the lithium niobium oxide coated cathode active material particles. The atomizing is performed via an atomizer. The drying chamber has a gas flow to carry the atomized solution therethrough. The drying is performed via the gas flow within the drying chamber.

According to further aspects of the present disclosure, the atomizing, the introducing, and the drying are performed at steady state.

According to further aspects of the present disclosure, the non-aqueous solution includes lithium niobium ethoxide in an amount between 0.1 wt % and 5 wt % on the basis of the pristine cathode active material.

According to further aspects of the present disclosure, the cathode active material is a lithium- and manganese-rich material, a nickel manganese cobalt material, a lithium nickel cobalt aluminum material, a lithium nickel cobalt manganese aluminum material, a lithium iron phosphate material, a lithium manganese iron phosphate material, a lithium nickel oxide material, or a combination thereof.

According to further aspects of the present disclosure, the cathode active material is a lithium- and manganese-rich material.

According to further aspects of the present disclosure, the drying within the drying chamber occurs at a temperature from 40° C. to 90° C.

According to further aspects of the present disclosure, the drying within the drying chamber occurs at a temperature of 70° C.

According to further aspects of the present disclosure, the gas flow has a flow rate of 20 L/min.

According to further aspects of the present disclosure, each of the lithium niobium oxide coated cathode active material particles includes a coating of lithium niobium oxide defining a uniform phase.

According to further aspects of the present disclosure, the lithium niobium oxide coating defines a uniform thickness, the uniform thickness is 0.1 nm to 5 nm, and the lithium niobium oxide coating shares a macrostructure of the pristine cathode active material particle.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIG. 1 illustrates a schematic battery cell including coated electroactive material particles, according to aspects of the present disclosure;

FIG. 2 illustrates a schematic system for producing coated electroactive-material particles, according to aspects of the present disclosure;

FIG. 3 illustrates an example spray-dry process for producing coated electroactive-material particles, according to aspects of the present disclosure;

FIG. 4 depicts a transmission electron microscope image of an example atomic layer deposition coated electroactive-material particle;

FIG. 5 depicts a transmission electron microscope image of an example spray-dry coated electroactive-material particle produced according to aspects of the present disclosure; and

FIG. 6 depicts a chart of the specific capacity and the capacity retention of example battery cells over charge/discharge cycles.

### DETAILED DESCRIPTION

The following detailed description is merely exemplary in nature and is not intended to limit the application and uses. Furthermore, there is no intention to be bound by expressed or implied theory presented in the preceding introduction, summary, or brief description of the drawings or the following detailed description.

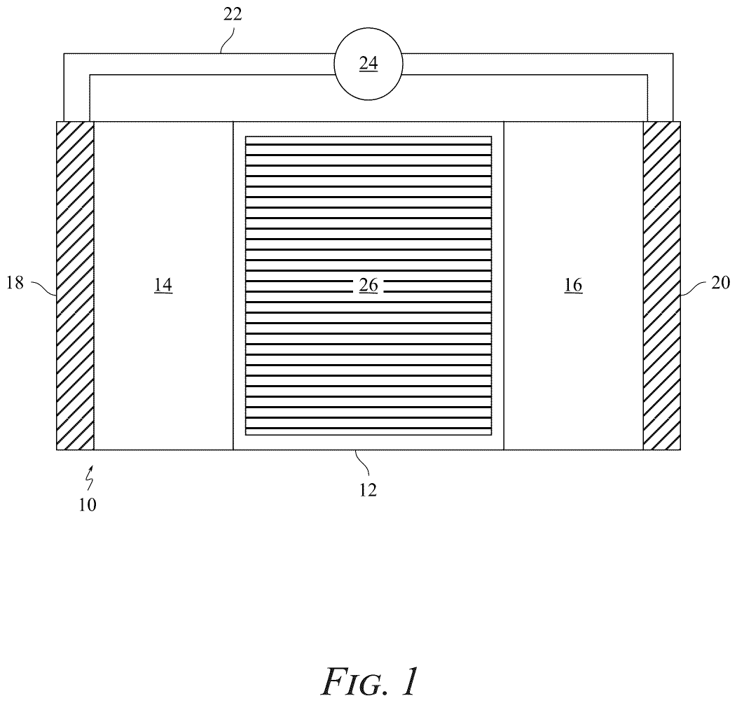

FIG. 1 illustrates a schematic battery cell 10 (alternatively referred to as an electrochemical cell), according to aspects of the present disclosure. The battery cell 10 may be incorporated into a desired battery architecture, such as a stacked, winding, or cylindrical cell architectures. The battery cell 10 includes a separator 12 disposed between a pair of electrodes (anode 14 and cathode 16). The separator 12 is configured to electronically isolate the anode 14 and the cathode 16. The separator 12 may be a non-conductive, porous polymeric membrane. The anode 14 is disposed on a first current collector 18 and the cathode 16 is disposed on a second current collector 20, with each respective current collector being disposed opposite the separator 12.

The anode 14 is configured to, via the anode electroactive material, intercalate ions while the battery cell 10 is charging and de-intercalate ions while the battery cell 10 is discharging. The anode active material may be, for example, a lithiated material, a silicon material, a silicon oxide material, a graphite material, combinations thereof, and the like. In some aspects, the lithiated material is a lithiated silicon material with a general formula of Li_{y}SiOₓ, where y is between 0 and 1 and x is between 0 and 2. In certain aspects, the lithiated material is a lithiated silicon-rich oxide, where x is less than 1. The electroactive material may have a suitable morphology selected from the group consisting of nanoparticles, nanofibers, nanotubes, microparticles, combinations thereof, and the like.

The anode 14 is loaded to optimize operating characteristics of the battery cell 10. The anode may further include a carbon material to enhance characteristics of the anode 14. For example, the carbon material may be selected to promote a particular morphology of the electroactive material, enhance ion intercalation and deintercalation, optimize mechanical properties of the anode 14, combinations thereof, and the like. The carbon material may be selected from the group consisting of graphite, hard carbon, or soft carbon.

The cathode 16 is configured to, via the cathode electroactive material, intercalate the ions received from the anode 14 when the battery cell 10 is discharging and de-intercalate the ions for transport to the anode 14 while the battery cell 10 is charging. The cathode active material is cooperative with the anode active material to facilitate ion flow and electron flow between the anode 14 and the cathode 16.

The cathode active material may be a transition-metal electroactive material, such as a transition-metal-rich electroactive material. In some aspects, the cathode active material is selected from the group consisting of a lithium- and manganese-rich (“LMR”) material, a nickel manganese cobalt (“NCM” or “NMC”) material, a lithium nickel cobalt aluminum (“NCA”) material, a lithium nickel cobalt manganese aluminum (“NCMA”) material, a lithium iron phosphate (“LFP”) material, a lithium manganese iron phosphate (“LMFP”) material, a lithium nickel oxide (“LNO”) material, and combinations thereof.

The LMR material may be an LMR oxide or an LMR layered oxide denoted by the formula x Li₂MnO₃ (1-x) LiMO₂, where M is one or more transition metals. In certain aspects, M is selected from the group consisting of manganese, nickel, cobalt, iron, and combinations thereof. The NCM material may be denoted by the formula Li[Ni_{1-x-y}CoₓMn_{y}]O₂. The NCA material may be denoted by the formula Li[Ni_{1-x-y}CoₓAl_{y}]O₂. The NCMA material may be denoted by the formula Li[Ni_{1-x-y}CoₓMn_{y}Al_{z}]O₂. The LFP material may be denoted by the formula LiFePO₄. The LMFP material may be denoted by the formula LiMnₓFe_{1-y}PO₄. The LNO material may be denoted by the formula LiNiO₂.

The first current collector 18 and the second current collector 20 are configured to collect free electrons from and distribute them to the adjacent anode 14 and cathode 16. The free electrons are moved between the first current collector 18 and the second current collector 20 via an external circuit 22. The external circuit 22 may include an external device 24 which may be a load that consumes electric power from the battery cell 10 and/or a power source that provides electric power to the battery cell 10.

Each of the anode 14, the cathode 16, and the separator 12 may further include an electrolyte 26. For example, pores of the anode 14, the cathode 16, and/or the separator 12 may be infilled with the electrolyte 26. The electrolyte 26 is formed from an electrolyte solution and promotes movement of ions between the anode 14 and the cathode 16 during charging and discharging of the electrochemical cell 10.

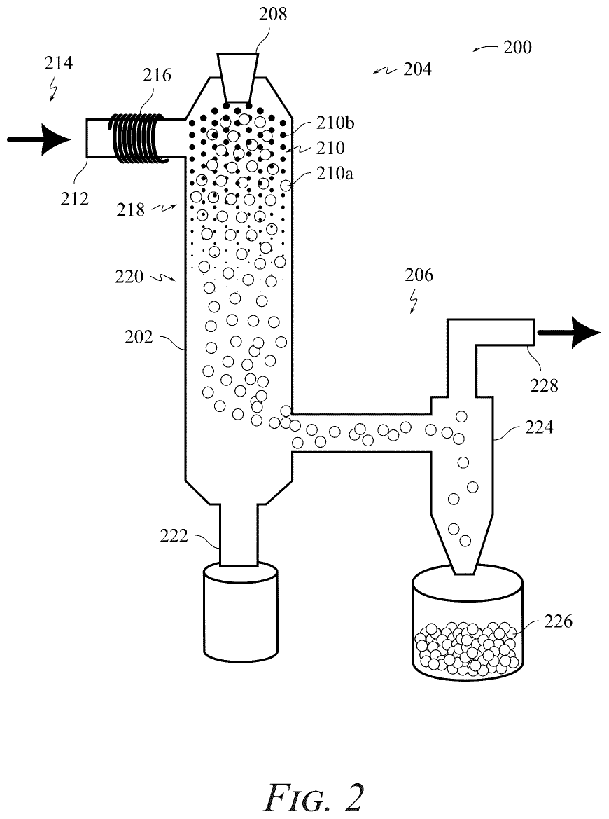

FIG. 2 illustrates a system 200 for producing coated electroactive-material particles. The system 200 includes a drying chamber 202 having an input side 204 and an output side 206.

The input side 204 includes an atomizer 208 and a gas inlet 212. The atomizer 208 is configured to aerosolize a non-aqueous solution 210 during introduction of the non-aqueous solution 210 into the drying chamber 202. The non-aqueous solution 210 includes a pristine electroactive material 210a and a coating precursor 210b in a non-aqueous solvent.

The pristine electroactive material 210a includes particles having a predetermined particle size distribution and a predetermined surface morphology. In some aspects, the pristine electroactive material is a cathode electroactive material selected from the group consisting of an LMR material, an NMC material, an NCA material, an NCMA material, a LFP material, an LMFP material, an LNO material, and combinations thereof. In certain aspects, the pristine electroactive material is an LMR material. The pristine electroactive material 210a may be a layered electroactive material, such as an electroactive material including layers of different lithium/metal and/or lithium/transition-metal oxides.

The coating precursor 210b is configured to undergo a reaction under process conditions that deposits a coating onto the surface of the pristine electroactive material 210a. In some aspects, the coating precursor 210b is lithium niobium ethoxide. The lithium niobium ethoxide may be present in an amount between 0.1 wt % and 5 wt % on the basis of the pristine electroactive material. In certain aspects, the lithium niobium ethoxide is present in an amount of 1 wt % on the basis of the pristine electroactive material.

The atomizer 208 is selected such that the aerosolized non-aqueous solution 210 includes singulated pristine electroactive material 210a particles and coating precursor 210b droplets with a predetermined size distribution.

The gas inlet 212 is configured to introduce a drying gas 214 into the input side 204 of the drying chamber 202. In the illustrated example, the drying gas 214 is configured to heat the aerosolized solution 210 and vaporize the solvent. The flow rate of the drying gas 214 is selected to entrain the particles, such as the pristine electroactive-material particles and the coated electroactive-material particles, such that the dried particles are carried out of the drying chamber 202 by the drying gas 214.

The drying gas 214 is selected to be inert to or facilitate kinetics of the coating reaction. In some aspects, the drying gas 214 is air. In some aspects, the drying gas 214 is an inert gas such as nitrogen, argon, carbon dioxide, combinations thereof, and the like. The drying gas 214 may be conditioned to include a predetermined concentration of water vapor (e.g., conditioned air). Additionally, or alternatively, water vapor may be introduced into the drying chamber 202 through a separate input.

The gas inlet 212 may include a heating unit 216 configured to heat the drying gas 214 to a desired inlet temperature and/or provide fine temperature control for a pre-heated drying gas 214. In some aspects, the heating unit 216 is a heat exchanger with a heating fluid. In some aspects, the heating unit 216 is a resistance heater.

The drying chamber 202 includes a mixing portion 218 proximate to the input side 204, a drying portion 220 downstream from the mixing portion 218. In the mixing portion 218, the drying gas 214 is mixed with the aerosolized solution 210 to carry the aerosolized solution 210 to the drying portion 220.

The gas inlet 212 is positioned relative to the atomizer 208 such that the aerosolized solution 210 and drying gas 214 are well-mixed and substantially homogenous prior to entering the drying portion 220. In examples with a separate water vapor input, the water vapor input may be positioned to mix the water vapor with the non-aqueous solution 210 prior to, concurrently with, or after mixing of the solution 210 with the drying gas 214 and prior to mixture entering the drying portion 220.

The drying portion 220 is sized and shaped to provide a predetermined residence time such that, under process conditions, each of the pristine cathode active material particles is coated with lithium niobate prior to reaching the output side 206. The coating defines a uniform thickness. In some aspects, the coating defines a thickness between 0.1 nm to 5 nm. In certain aspects, the coating defines a thickness of 1 nm.

The drying portion 220 may include components such as turbulators or other devices to control flow properties and optimize uniformity of the environment experienced by each particle during the drying process.

One or more separators are included downstream from the drying portion 220. The separators, such as pre-separator 222 and cyclone separator 224, are configured to separate the coated particles 226 from the other components of the stream.

The pre-separator 222 may be configured to separate residual liquid and/or other components that are too large to be entrained by the stream of the drying gas. For example, in the illustrated example, the pre-separator 222 is configured to collect residual liquid that has collected on components of the drying chamber 202 (e.g., walls) or that remains after the mixture exits the drying portion 220. The residual liquid may be, for example, coating precursor 210b in solution, solvent, and/or water.

The cyclone separator 224 is configured to form the drying gas stream into a vortex with a cut point that separates the dry coated particles 226 from smaller components in the drying gas stream, such as the drying gas 214 and any unreacted coating precursor solids. The dry coated particles 226 are collected for incorporation into an electrode of a battery cell, while the drying gas 214 and smaller components exit the system 200 via the exhaust outlet 228. The exhaust gas may be processed to recover at least a portion of the drying gas 214 and/or coating precursor solids therein. The recovered drying gas 214 may be recycled into the system, for example via the gas inlet 212, and the recovered coating precursor may be recycled into future non-aqueous solution 210.

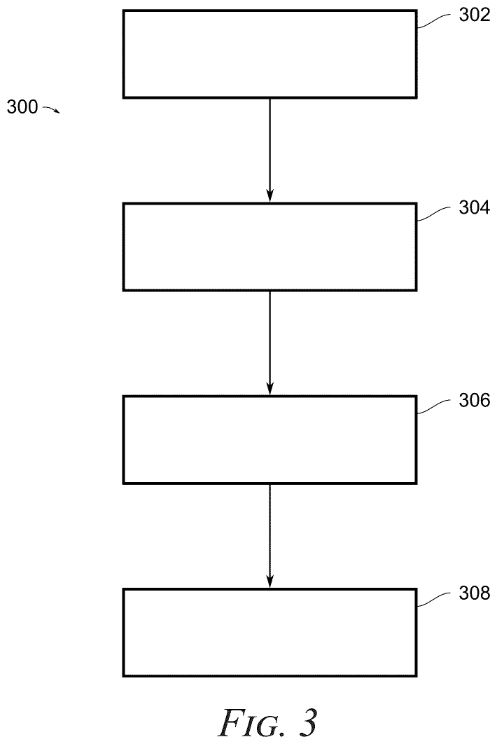

FIG. 3 illustrates an example spray-dry process 300 for producing coated electroactive-material particles. The process conditions for the spray-dry process 300 are selected to provide a generally homogenous reaction environment around each electroactive-material particle during the coating process. In some aspects, the process conditions are further selected to produce dry coated particles 226 prior to separation or isolation of the particles.

At block 302, a non-aqueous solution is atomized to produce an atomized precursor solution. The atomized precursor solution includes singulated pristine electroactive material particles and coating precursor droplets. The coating precursor droplets include the coating precursor in a solvent. The coating precursor is selected such that drying of the coating precursor droplets deposits a uniform coating on the pristine electroactive-material particles. The droplets are sized to optimize contact between the lithium niobium ethanoate and the surface of the singulated electroactive-material particles during the drying process. In the illustrated example, the pristine electroactive material particles 210a are a pristine LMR material, the coating precursor 210b is lithium niobium ethoxide, and the solvent is ethanol.

At block 304, the atomized precursor solution is introduced into a drying chamber 202. The drying chamber 202 includes a gas flow therethrough that is configured carry the atomized solution through the drying chamber 202 toward an output. The gas flow may be also configured to entrain the coated particles.

At block 306, the atomized precursor solution is dried to produce dry coated particles. For example, the coating precursor 210b of lithium niobium ethoxide in ethanol may be hydrolyzed during the drying to deposit a uniform lithium niobate coating onto the pristine LMR particles. The process temperature is selected to vaporize the solvent without degrading kinetics of the coating process and produce uniformly coated electroactive-material particles upon completion of the drying process. In some aspects, the process temperature is selected from temperatures in the range of 40° C. to 90° C. In certain aspects, the process temperature is 70° C.

At block 308, the dry coated particles are isolated for use in, for example, battery cell electrodes. Isolation of the dry coated particles may include, for example, physical processes such as cyclonic separation. The dry coated particles may further be isolated into a plurality of fractions based on, for example, size of the dry coated particles.

Beneficially, the spray-dry process 300 may be carried out at steady state to continuously intake non-aqueous solution 210 and produce dry coated particles 226 for a complete process cycle. The process cycle is not limited by volume of products or reactants, but only ancillary considerations such as maintenance of system components.

As understood by one of skill in the art, the present disclosure is susceptible to various modifications and alternative forms, and some representative embodiments have been shown by way of example in the drawings and described in detail above. It should be understood, however, that the novel aspects of this disclosure are not limited to the particular forms illustrated in the appended drawings. Rather, the disclosure is to cover modifications, equivalents, combinations, sub-combinations, permutations, groupings, and alternatives falling within the scope and spirit of the disclosure and as defined by the appended claims.

As used herein, unless the context clearly dictates otherwise: the words “and” and “or” shall be both conjunctive and disjunctive, unless the context clearly dictates otherwise; the word “all” means “any and all” the word “any” means “any and all”; the word “including” means “including without limitation”; and the singular forms “a”, “an”, and “the” includes the plural referents and vice versa.

Numerical values of parameters (e.g., of quantities or conditions) in this specification, unless otherwise indicated expressly or clearly in view of the context, including the appended claims, are to be understood as being modified by the term “about” whether or not “about” actually appears before the numerical value. The numerical parameters set forth herein and in the attached claims are approximations that may vary depending upon the desired properties sought to be obtained by the present disclosure. At the very least, and not as an attempt to limit the application of the doctrine of equivalents to the scope of the claims, each numerical parameter should at least be construed in view of the number of reported significant digits and by applying ordinary rounding techniques.

Words of approximation, such as “approximately,” “about,” “substantially,” and the like, may be used herein in the sense of “at, near, or nearly at,” “within 0-10% of,” or “within acceptable manufacturing tolerances,” or a logical combination thereof, for example.

While the metes and bounds of the term “about” are readily understood by one of ordinary skill in the art, the term “about” indicates that the stated numerical value or property allows imprecision. If the imprecision provided by “about” is not otherwise understood in the art with this ordinary meaning, then “about” indicates at least variations that may arise from ordinary methods of measuring and using such parameters. For example, if not otherwise understood in the art, the term “about” means within 10% (e.g., +10%) of the stated value.

While the metes and bounds of the term “substantially” are readily understood by one of ordinary skill in the art, the term “substantially” indicates that the stated numerical value or property allows some imprecision. If the imprecision provided by “substantially” is not otherwise understood in the art with this ordinary meaning, then “substantially” indicates at least variations that may arise from manufacturing processes and measurement of such parameters. For example, if not otherwise understood in the art, the term “substantially” means within 5% (e.g., +5%) of the stated value.

While the metes and bounds of the term “essentially” are readily understood by one of ordinary skill in the art, the term “essentially” indicates that the stated numerical value or property allows some slight imprecision. If the imprecision provided by “essentially” is not otherwise understood in the art with this ordinary meaning, then “essentially” indicates at least negligible variations in desired parameters that may be impracticable to overcome. For example, if not otherwise understood in the art, the term “essentially” means within 1% (e.g., +1%) of the stated value.

While the metes and bounds of the term “pure” are readily understood by one of ordinary skill in the art, the term “pure” indicates that the compound may include very slight traces of other materials. If the imprecision provided by “pure” is not otherwise understood in the art with this ordinary meaning, then “pure” indicates at least variations that may arise from separation processes and measurement of such parameters. For example, if not otherwise understood in the art, the term “pure” means above 99.9% of the stated material.

It is to be understood that the ranges provided herein include the stated range, subranges within the stated range, and each value within the stated range.

While the best modes for carrying out the disclosure have been described in detail, those familiar with the art to which this disclosure relates will recognize various alternative designs and embodiments for practicing the disclosure within the scope of the appended claims.

### Examples

Three categories of LMR cathode electroactive material samples were prepared. The three categories included pristine LMR particles (“uncoated particles”), LMR particles coated with lithium niobate via atomic layer deposition (“ALD particles”), and LMR particles coated with lithium niobate via the spray-dry process (“SD particles”).

The uncoated LMR particles are 67 wt % manganese, 17 wt % cobalt, and 16 wt % nickel with an average size of 9 μm.

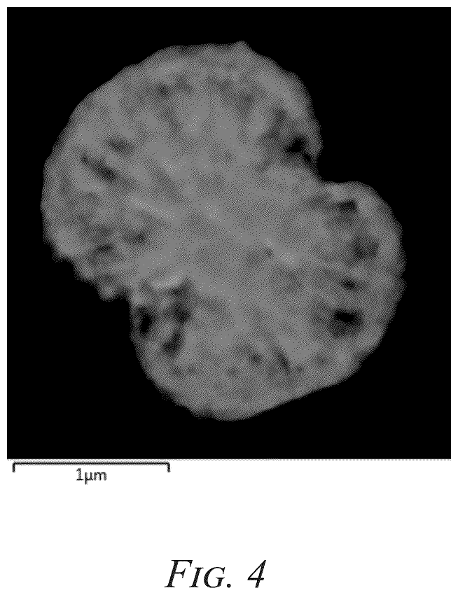

The ALD particles were formed by coating the pristine LMR particles in a thin film via atomic layer deposition. The thin film had a thickness of 1 nm and an overall stoichiometry of LiNbO₃. A TEM image of an example ALD particle is reproduced in FIG. 4.

The SD particles were formed by coating the LMR particles in a thin film via a spray-dry process. The thin film had a thickness of 1 nm and an overall stoichiometry of LiNbO₃. A solution of lithium niobium ethoxide and LMR particles in ethanol was prepared. The solution contained 10 g of LMR particles and was 1 wt % lithium niobium ethoxide on the basis of the LMR particles.

The drying chamber had a drying gas flowed therethrough until the temperature of the drying chamber stabilized. The drying gas had an airflow of 20 L/min and temperature of 70° C. After the drying chamber reached the desired temperature, the solution was introduced to the chamber via an atomizer with a volumetric flow and pressure sufficient to provide singulated pristine LMR particles and droplets small enough to allow the lithium niobium ethoxide to coat the pristine LMR particles and to allow the ethanol to vaporize before exiting the drying chamber. The atomizer nozzle was cleaned as needed to maintain steady state operation of the process. The atomized solution traversed the drying chamber vertically in the same direction as the drying gas.

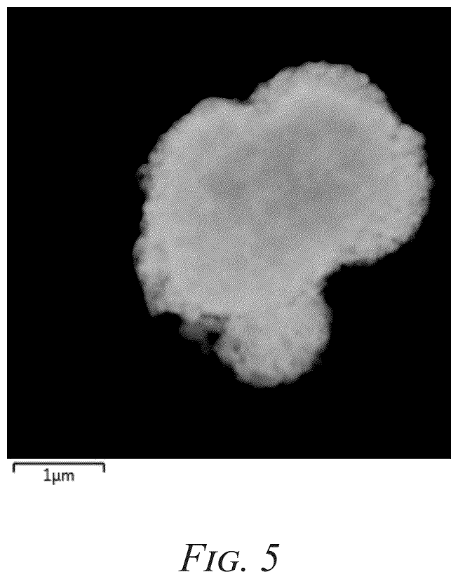

After the ethanol was vaporized, the drying gas and dry coated particles entrained therewith exited the drying chamber laterally. The entrained particles were separated from the drying gas via cyclonic separation. The dry coated particles were collected and calcined at 500° C. for 5 hours in air. A TEM image of an example SD particle is reproduced in FIG. 5.

Each of the three categories was incorporated into respective battery cells for comparative testing of specific capacities and coulombic efficiencies over charge/discharge cycles. Each cathode included the respective LMR particles, carbon black, and polyvinylidene fluoride in a ratio of 94/3/3 parts by weight, respectively, to provide a theoretical capacity of 5.5 mAh/cm². Each anode included 5.5 wt % silicon oxide/graphite to provide a theoretical capacity equal to that of the cathodes. The cells also included 50 μL of an electrolyte containing 1.2 M LiPF₆ in a 1-to-4 mixture of fluoroethylene carbonate and dimethyl carbonate and 1 wt % LiPO₂F₂. Each of the full cells was subjected to the same formation cycle and life cycle protocols.

The formation cycle protocol for the battery cells included a constant-current charging phase, a constant-voltage charging phase, and a constant current discharge phase. The constant current charging phase used a current with a C-rating of C/20, which was supplied until the voltage reached 4.6 V. After the voltage reached 4.6 V, the constant voltage charging phase began, and a voltage of 4.6 V was maintained until the current reached a C-rating of C/50. The constant-current discharge phase used a current with a C-rating of C/20, which was drawn until reaching a voltage of 2.0 V.

The life cycle protocol for the battery cells included constant-current charging phase, a constant-voltage charging phase, and a constant current discharge phase. The constant current charging phase used a current with a C-rating of C/3, which was supplied until the voltage reached 4.6 V. After the voltage reached 4.6 V, the constant voltage charging phase began, and a voltage of 4.6 V was maintained until the current reached a C-rating of C/20. The constant-current discharge phase used a current with a C-rating of C/3, which was drawn until reaching a voltage of 2.0 V.

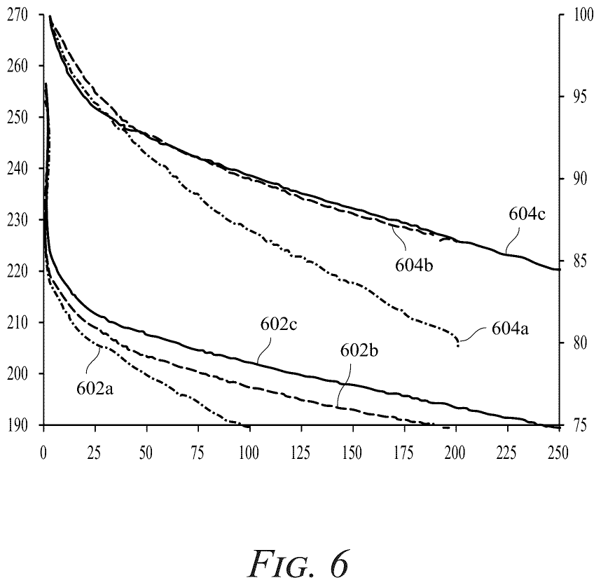

FIG. 6 depicts a chart of both the specific capacity and the capacity retention of the example battery cells over charge/discharge cycles. Lines 602a-c denote the specific capacity, in mAh/g, of the tested battery cells. Lines 604a-c denote the capacity retention percentage of the tested battery cells.

Line 602a denotes the specific capacity of an example cell incorporating the uncoated particles. Line 602b denotes the specific capacity of an example cell incorporating the ALD particles. Line 602c denotes the specific capacity of an example cell incorporating the SD particles. As can be seen, the uncoated particles begin with the lowest specific capacity, the ALD particles have a higher specific capacity than the uncoated particles, and the SD particles have a higher specific capacity than both the uncoated particles and the ALD particles. Moreover, while the specific capacity declines with each cycle, battery cells with the SD particles maintain the highest specific capacity of the three categories over all tested cycles.

Line 604a denotes the capacity retention of an example cell incorporating the uncoated particles. Line 604b denotes the capacity retention of an example cell incorporating the ALD particles. Line 604c denotes the capacity retention of an example cell incorporating the SD particles. As can be seen, the uncoated particles lose capacity retention at a faster rate than either the ALD particles or the SD particles. While the ALD particles and the SD particles have a similar trend, after cycle 75, the SD particles consistently maintain a higher capacity retention than the ALD particles.

Further, each of the three categories was incorporated into respective half-cells for comparative testing of first cycle specific capacity and Coulombic efficiencies. Each of the three categories was incorporated into respective half-cells for comparative testing of specific capacities and coulombic efficiencies over charge/discharge cycles. Each cathode included the respective LMR particles, carbon black, and polyvinylidene fluoride in a ratio of 94/3/3 parts by weight, respectively, to provide a theoretical capacity of 5.5 mAh/cm². Each anode was 0.6 mm of pure lithium metal. The half-cells also included 50 μL of an electrolyte containing 1.2 M LiPF₆ in a 1-to-4 mixture of fluoroethylene carbonate and dimethyl carbonate and 1 wt % LiPO₂F₂. Each of the half-cells was subjected to the same formation cycle and life cycle protocols.

The formation cycle protocol for the half-cells included a constant-current charging phase, a constant-voltage charging phase, and a constant current discharge phase. The constant current charging phase used a current with a C-rating of C/20, which was supplied until the voltage reached 4.6 V. After the voltage reached 4.6 V, the constant voltage charging phase began, and a voltage of 4.6 V was maintained until the current reached a C-rating of C/50. The constant-current discharge phase used a current with a C-rating of C/20, which was drawn until reaching a voltage of 2.0 V.

The life cycle protocol for the half-cells included constant-current charging phase, a constant-voltage charging phase, and a constant current discharge phase. The constant current charging phase used a current with a C-rating of C/3, which was supplied until the voltage reached 4.6 V. After the voltage reached 4.6 V, the constant voltage charging phase began, and a voltage of 4.6 V was maintained until the current reached a C-rating of C/20. The constant-current discharge phase used a current with a C-rating of C/3, which was drawn until reaching a voltage of 2.0 V.

Each of the half-cells was tested for first cycle coulombic efficiency and first C/3 discharge specific capacity. For the uncoated particle half-cell, the first C/3 discharge specific capacity was 225.9 mAh/g and the first cycle coulombic efficiency was 82.5%.

The ALD particle half-cells showed a lower specific capacity and coulombic efficiency than the uncoated particle half-cells. Specifically, for the ALD particle half-cell, the first C/3 discharge specific capacity was 219.3 mAh/g and the first cycle coulombic efficiency was 82.0%.

The SD particle half-cells showed a higher specific capacity and coulombic efficiency than both the uncoated particle half-cells and the ALD particle half-cells. Specifically, for the SD particle half-cell, the first C/3 discharge specific capacity was 232.7 mAh/g and the first cycle coulombic efficiency was 84.9%.

What is claimed is:

1. A method comprising:
atomizing, via an atomizer, a non-aqueous solution including lithium niobium ethoxide and pristine cathode active material particles to produce an atomized solution;
introducing the atomized solution into a drying chamber having a gas flow to carry the atomized solution therethrough; and
drying, via the gas flow within the drying chamber, the atomized solution to produce lithium niobium oxide coated cathode active material particles.

2. The method of claim 1, wherein the atomizing, the introducing, and the drying are performed at steady state.

3. The method of claim 1, wherein the non-aqueous solution includes lithium niobium ethoxide in an amount between 0.1 wt % and 5 wt % on a basis of the pristine cathode active material.

4. The method of claim 1, wherein the cathode active material is a lithium- and manganese-rich material, a nickel manganese cobalt material, a lithium nickel cobalt aluminum material, a lithium nickel cobalt manganese aluminum material, a lithium iron phosphate material, a lithium manganese iron phosphate material, a lithium nickel oxide material, or a combination thereof.

5. The method of claim 1, wherein the cathode active material is a lithium- and manganese-rich material.

6. The method of claim 1, wherein the drying within the drying chamber occurs at a temperature from 40° C. to 90° C.

7. The method of claim 1, wherein the drying within the drying chamber occurs at a temperature of 70° C.

8. The method of claim 1, wherein the gas flow has a flow rate of 20 L/min.

9. The method of claim 1, wherein each of the lithium niobium oxide coated cathode active material particles includes a coating of lithium niobium oxide defining a uniform phase.

10. The method of claim 9, wherein the lithium niobium oxide coating defines a uniform thickness, the uniform thickness is 0.1 nm to 5 nm, and the lithium niobium oxide coating shares a macrostructure of the pristine cathode active material particle.

11. Lithium niobium oxide coated cathode active material particles formed by:
atomizing, via an atomizer, a non-aqueous solution including lithium niobium ethoxide and pristine cathode active material particles to produce an atomized solution;
introducing the atomized solution into a drying chamber having a gas flow to carry the atomized solution therethrough; and
drying, via the gas flow within the drying chamber, the atomized solution to thereby produce the lithium niobium oxide coated cathode active material particles.

12. The lithium niobium oxide coated cathode active material particles of claim 11, wherein the atomizing, the introducing, and the drying are performed at steady state.

13. The lithium niobium oxide coated cathode active material particles of claim 11, wherein the non-aqueous solution includes lithium niobium ethoxide in an amount between 0.1 wt % and 5 wt % on a basis of the pristine cathode active material.

14. The lithium niobium oxide coated cathode active material particles of claim 11, wherein the cathode active material is a lithium- and manganese-rich material, a nickel manganese cobalt material, a lithium nickel cobalt aluminum material, a lithium nickel cobalt manganese aluminum material, a lithium iron phosphate material, a lithium manganese iron phosphate material, a lithium nickel oxide material, or a combination thereof.

15. The lithium niobium oxide coated cathode active material particles of claim 11, wherein the cathode active material is a lithium- and manganese-rich material.

16. The lithium niobium oxide coated cathode active material particles of claim 11, wherein the drying within the drying chamber occurs at a temperature from 40° C. to 90° C.

17. The lithium niobium oxide coated cathode active material particles of claim 11, wherein the drying within the drying chamber occurs at a temperature of 70° C.

18. The lithium niobium oxide coated cathode active material particles of claim 11, wherein the gas flow has a flow rate of 20 L/min.

19. The lithium niobium oxide coated cathode active material particles of claim 11, wherein each of the lithium niobium oxide coated cathode active material particles includes a coating of lithium niobium oxide defining a uniform phase.

20. The lithium niobium oxide coated cathode active material particles of claim 19, wherein the lithium niobium oxide coating defines a uniform thickness, the uniform thickness is 0.1 nm to 5 nm, and the lithium niobium oxide coating shares a macrostructure of the pristine cathode active material particle.
